(19) United States
(12) Patent Application Publication
(10) Pub. No.: US 2009/0043557 A1
(43) Pub. Date: Feb. 12, 2009

(54) Method, System, and Apparatus for Emulating Functionality of a Network Appliance in a Logically Partitioned Environment

(76) Inventors: Steven J. Branda, Rochester, MN (US); Christopher J. Kundinger, Rochester, MN (US); Adam T. Stallman, Rochester, MN (US); Brett M. Yokom, Rochester, MN (US)

Correspondence Address: CANTOR COLBURN LLP - IBM ROCHESTER DIVISION, 20 Church Street, 22nd Floor, Hartford, CT, 06103, US

(21) Appl. No.: 11/835,486

(22) Filed: Aug. 8, 2007

(51) Int. Cl. G06G 7/62

(52) U.S. Cl. 703/13

(57) ABSTRACT

A network appliance is emulated in a logically partitioned environment. Activity of a logical partition (LPAR) acting as a network appliance is monitored. When a change in activity occurs in the LPAR acting as the network appliance, a set of business logic partitions served by the LPAR acting as the network appliance is determined, and resource utilization of each business logic partition served by the LPAR acting as the network appliance is determined. A determination is also made whether each business logic partition served by the LPAR acting as the network appliance needs more or less resources. Availability of resources is determined, and resources are allocated or deallocated to or from the business logic partitions served by the LPAR acting as the network appliance based on the need for resources and the availability of resources for each business logic partition.

### BACKGROUND

The present invention relates generally to logically partitioned environments, and, more particularly, to network appliance emulation in a logically partitioned environment.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

The market momentum of Service Oriented Architecture, WebServices, Security and eXtensible markup language (XML) is propelling the sales of network appliances designed to offload the processing for some of these tasks from the application server. Examples of such network appliances include IBM's DataPower XML network appliance boxes, the details of which may be found at http://www-306.ibm.com/software/integration/datapower/xs40/. Another example of a network appliance is WatchGuard's FireBox, which handles network security. Details of this appliance may be found at http://www.watchguard.com/products/peak-e.asp/.

Current approaches of managing network appliances are proving to be useful in many user scenarios, but they do not offer optimum value to users with large enterprise machines that are capable of virtualization. Users using virtualized enterprise hardware enjoy many advantages that are unique to this environment. Some of the main advantages are integrated failover, High Availability (HA) support, and dynamic movement of system resources for Logical Partitions (LPARs).

An LPAR is a virtual machine that is assigned a portion of a computer's processors, memory, and hardware resources. Each LPAR operates independently with its own operating system and applications. The number of logical partitions that can be created depends on the system. Typically, partitions are used for different purposes, such as database operation, client/server operations, web server operations, test environments, and production environments. Each partition can communicate with the other partitions as if each partition were a separate machine.

Conventional standalone network appliances cannot take advantage of the features available in a logically partitioned environment. This includes integrated failover available on enterprise systems, like IBM's iSeries, pSeries and zSeries, because LPARs and virtualization are key components in this built in failover. Also, users are accustomed to the low latency of communication between LPARs on the internal system bus. A standalone network appliance is limited to Ethernet/FDDI levels of throughput and performance, which is not comparable to the speed of the internal system bus in an enterprise server.

Also, enterprise servers give users advanced resource management in the form of Dynamic Logical Partitioning (DLPAR) features. DLPAR provides the ability to logically attach and detach a managed system's resources to and from a logical partition's operating system without rebooting. Conventional standalone network appliance boxes do not have the capability to support DLPAR. Thus, users are unable to enjoy the advantages of these network appliances, without having to surrender so many of the advantages of their enterprise level systems.

### SUMMARY

According to an exemplary embodiment, a method, a system, and an apparatus are provided for emulating a network appliance in a logically partitioned environment. Activity of a logical partition (LPAR) acting as a network appliance is monitored. When a change in activity occurs in the LPAR acting as the network appliance, a set of business logic partitions served by the LPAR acting as the network appliance is determined, and resource utilization of each business logic partition served by the LPAR acting as the network appliance is determined. A determination is also made whether each business logic partition served by the LPAR acting as the network appliance needs more or less resources. Availability of resources is determined, and resources are allocated or deallocated to or from the business logic partitions served by the LPAR acting as the network appliance based on the need for resources and the availability of resources for each business logic partition.

### BRIEF DESCRIPTION OF THE DRAWINGS

Referring to the exemplary drawings, wherein like elements are numbered alike in the several Figures:

FIG. 1 illustrates a system for emulating a network appliance in a logically partitioned environment according to an exemplary embodiment.

FIG. 2 illustrates a method for emulating a network appliance in a logically partitioned environment according to an exemplary embodiment.

### DETAILED DESCRIPTION

According to an exemplary embodiment, an addition to the virtualization layer in an enterprise level machine, like an IBM iSeries, pSeries or zSeries, will allow for the creation of LPARs that emulate the functionality of a Network Appliance.

According to an exemplary embodiment, when a user creates an LPAR in an enterprise level machine, he or she has the option of creating a predefined Network Appliance LPAR or creating an Operating System LPAR that will act like a Network Appliance LPAR. An example of a predefined Network Appliance LPAR may include IBM's DataPower appliance modified to have the capability of running as a specific add-on to the server of the LPAR system. Choosing this option would save the user any additional configuration. An example of a scenario in which a user may choose to create an Operating System LPAR may be if a user wanted to create a small Linux LPAR to run a firewall or spam filter. Allowing users to identify an LPAR partition as a Network Appliance allows the user to take advantage of the special functionality implemented in the virtualization layer for network appliances.

After creating the LPAR, the user may then identify which of the other LPARs on the system, i.e., which Business Logic Partitions, the Network Appliance LPAR is intended to serve. Defining the Network Appliance LPARs in this manner allows the virtualization system to integrate with them effectively. According to exemplary embodiments, various optimizations to LPARs and network appliance management are enabled via integration.

According to exemplary embodiments, the Business Logic Partitions may be configured to take advantage of DLPAR features so that their resources can be increased and decreased based on the load detected on the Network Appliance Partitions that serve them. In the description that follows, the Network Appliance Partition is described as an LPAR that has been configured to take advantage of DLPAR features, but it should be appreciated that the Network Appliance Partitions may also be implemented as an LPAR with a static set of system resources that cannot take advantage of DLPAR features.

The defined relationship between the Network Appliance LPAR and the LPARs running business logic can be used to effectively scale the resources of the Business Logic LPARs. When the system is not under much load, all of the Business Logic LPARs may scale down their resource usage. When the volume of client requests increases, the first LPAR they will hit will be the Network Appliance LPAR, because network appliances typically perform a fundamental transformation to the data that the business logic application needs to process the request. Some of these transformations include decoding secure socket layer, decoding Web Services security, caching data from multiple machines, XML transformations, and server load routing. The management software monitoring the activity of the LPARs knows that increased activity for the Network Appliance LPAR means increased activity for the Business Logic LPARs it serves. The management software may then preemptively increase the resource allocation for the Business Logic LPARs served by the particular Network Appliance LPAR, thereby improving the QoS of those Business Logic LPARs. Likewise, when the management software detects a decrease in the load on the Network Appliance LPAR, it can preemptively decrease the resources on the Business Logic LPARs that it serves. In this way, resource control and utilization are efficiently handled when a Network Appliance LPAR is being used.

As an alternative to the preemptive allocation/deallocation of resources described above, the management software may monitor the virtual network traffic to determine which Business Logic LPARs are receiving new traffic from the Network Appliance LPAR. These Business Logic LPARs may then be given additional resources. This may occur as part of a three-stage process. The first stage may include allocating some additional resources to all the Business Logic LPARs served by the Network Appliance LPAR, because at this point the nature of the client load is not known. The second stage may include providing additional resources to the Business Logic LPARs receiving new traffic from the Network Appliance LPAR. The third stage may include determining which Business Logic LPARs are not getting additional traffic from the Network Appliance LPAR. The additional resources given in the first stage may then be reclaimed and given to the Business Logic LPARs that are getting the additional load.

As yet another option, a Business Logic or Network Appliance LPAR may make a decision to increase/decrease its resources based on the current utilization of its resources. In this scenario, a Business Logic or Network Appliance LPAR may communicate with management software to have resources allocated/deallocated. The partition management software may then respond by appropriately increasing or decreasing the resources for LPARs which are associated with this LPAR in a Network Appliance/Business Logic relationship.

Since the Network Appliance LPARs are just LPARs acting as network appliances, they can use the underlying failover and HA functionality that is already built into the enterprise system. This allows enterprise users access to this new functionality, without requiring that the users learn new failover technologies or having to develop a method for integrating the network appliance failover methodology with that built into the enterprise system.

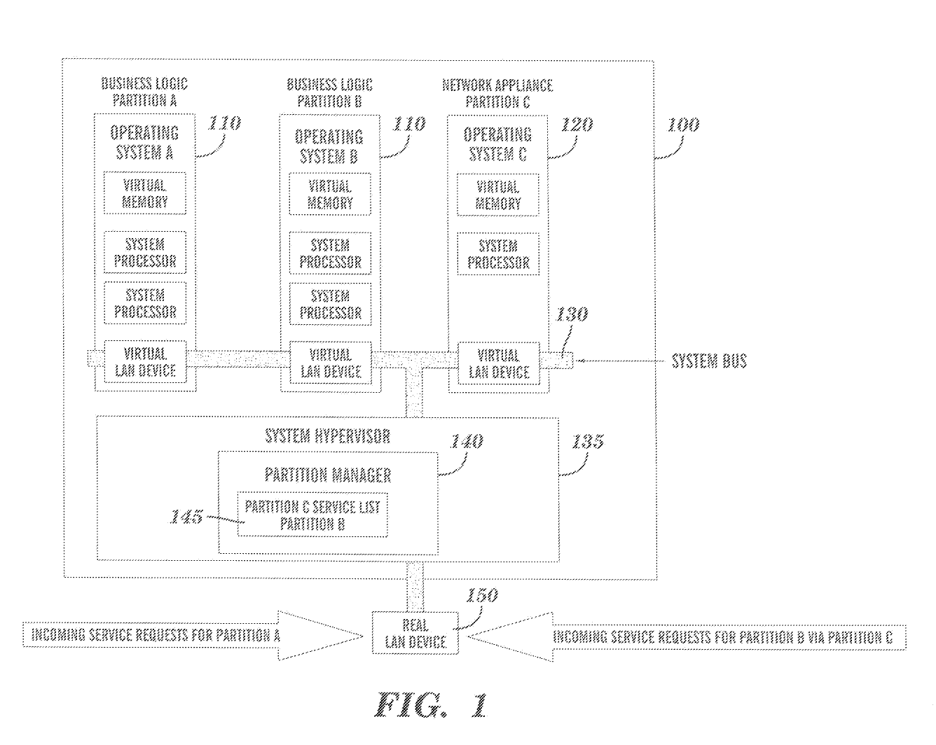

To illustrate the concepts describes above, FIG. 1 shows a system for emulating a network appliance in a logically partitioned environment according to an exemplary embodiment. The system includes a logically partitioned electronic device 100, e.g., an enterprise level logically partitioned machine, such as IBM's iSeries, pSeries or zSeries devices. The device 100 includes multiple LPARs, including Business Logic Partition A and Business Logic Partition B, both referenced with reference numeral 110 in FIG. 1, and an LPAR acting as a network appliance, referenced as Network Appliance Partition 120 in FIG. 1. Although two Business Logic Partitions 110 and one Network Appliance Partition 120 are shown in FIG. 1 for ease of illustration, it should be appreciated that the device 100 may include any number of logic partitions. As explained above, the Business Logic Partitions 110 may be implemented to allow for usage of DLPAR, while the Network Appliance Partition 120 may or may not make use of DLPAR functionality.

Each of the Partitions 110 and 120 are managed by a Partition Manager 140, which communicates with the Partitions via a system bus 130. The Business Logic Partitions 110 and the Network Appliance Partition 120 each include a virtual memory, a system processor, and a virtual LAN device. The Partitions communicate with each other via the system bus 130 and the virtual LAN devices.

The Business Logic Partitions 110 also utilize an operating system to control the primary operations of the Partitions 110 in the same manner as the operating system of a non-partitioned computer. In this sense, the Business Logic Partitions 110 act as conventional LPARs. The Network Appliance Partition 110 also includes an operating system. The Network Appliance Partition 120 differs from the Business Logic Partitions 110 in that it is used only to pre-process incoming service requests for one or more Business Logic Partitions that it serves.

Although the Network Appliance Partition 120 illustrated in FIG. 1 is shown as including an operating system for simplicity of illustration, it should be appreciated that a Network Appliance Partition may be implemented with a predefined Network Appliance as described in preceding paragraphs.

According to an exemplary embodiment, incoming service requests are received via a LAN device 150, which routes the requests through the System Hypervisor 135 over the system bus 130. The System Hypervisor 135, in turn, routes the requests to the Network Appliance Partition 120 or to the Business Logic Partitions 110 via the system bus 130. Allowing the Network Appliance LPAR 120 to operate over the internal system bus avoids the need for user to sacrifice I/O performance for using the network appliance functionally.

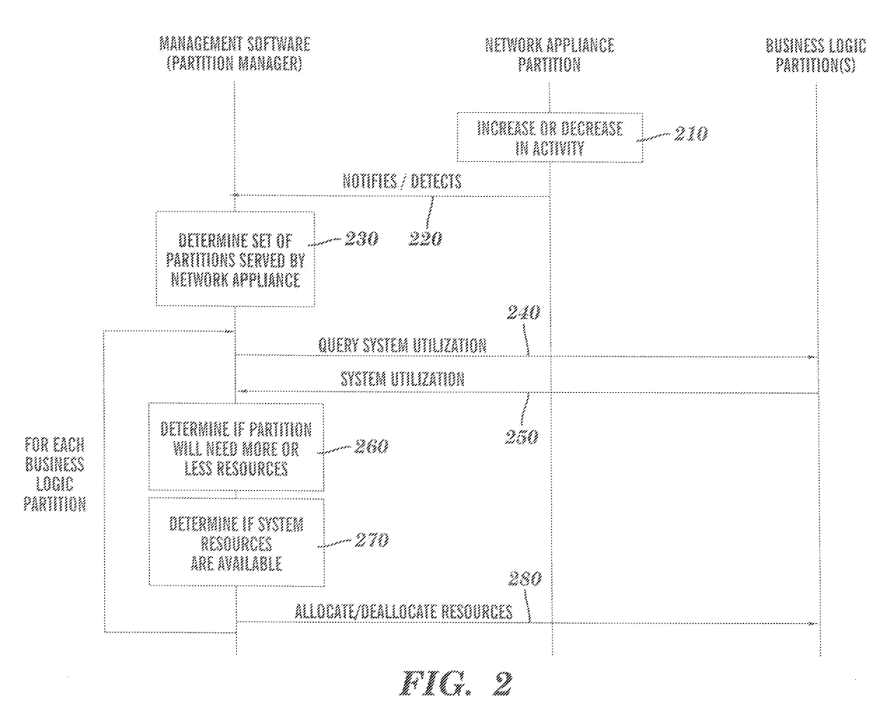

Each of the Business Logic Partitions 110 is statically and/or dynamically allocated a portion of available resources in the device 100. According to an exemplary embodiment, the Business Logic Partitions may be implemented with DLPAR so that their resources can be adjusted on the fly. A Partition Manager 140, which may be included within the System Hypervisor 135 (as illustrated) or may be implemented in a separate component, manages the Business Logic Partitions 110 and the Network Appliance Partition 120 and allocates resources to and from the Business Logic Partitions 110. The Partition Manager 140 is shown in FIG. 2 as including a Partition Service list 145 for each Network Appliance Partition 120. It should be appreciated, however, that the Partition Service List may be included in any agent or system that is monitoring the load on the Network Appliance Partition 120 and handling the corresponding allocating/deallocating of resources to and from the Business Logic Partitions 110 on the service list for the Network Appliance Partition 120 that is busy at the time.

The Business Logic Partitions 110 and the Network Appliance Partition 120 are isolated from each other except over the virtual network that runs over the system bus 130. In the example shown in FIG. 1, Business Logic Partition A receives service requests directly from external sources via, e.g., the System Hypervisor 135. Business Logic partition B receives service requests via Network Appliance Partition C, as the Business logic Partition B is listed in the list 145 as being served by the Network Appliance Partition C. The requests received by the Network Appliance Partition C via, e.g., the System Hypervisor 135, are pre-processed in the Network Appliance Partition C before being relayed to the Business Logic Partition B. Examples of preprocessing by the Network Appliance Partition C include, but are not limited to, SSL decryption or XML transformation.

FIG. 2 illustrates a method for emulating a network appliance in a logically partitioned environment according to an exemplary embodiment. As shown in FIG. 2, when a change in network activity in a LPAR acting as a network appliance occurs (210), Management Software (included in, e.g., the partition manager or in a separate device) is notified of the change or detects the change (220). A set of business logic partitions served by the Network Appliance Partition is determined (230) by the Management Software. Resource utilization of each business logic partition served by the Network Appliance Partition is determined by querying the Business Logic Partitions (240) and receiving responses from the Business Logic Partitions regarding resource utilization (250). For each Business Logic Partition, the Management Software determines whether the Business Logic Partition needs more or less resources (260), determines availability of resources (270), and allocates/dellocates resources to the Business Logic Partition, as appropriate (280). Although not shown, resources may be automatically preemptively allocated to the Business Logic Partitions served by the LPAR acting as a network appliance when activity is detected in the LPAR acting as the network appliance. Also, dynamic resources may be automatically deallocated from other LPARs in the network when activity is detected in the LPAR acting as a network appliance.

According to exemplary embodiments, enterprise level machine users are given a very clear path to implement the network appliance philosophy that is becoming popular, without requiring that the users abandon the advantages of virtualized hardware developed in recent years. This integration allows users to merge long lived technologies with the emerging technologies of Service Oriented Architecture (SOA) and XML.

As described above, exemplary embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for emulating a network appliance in a logically partitioned environment, comprising:
monitoring activity of a logical partition (LPAR) acting as a network appliance;
upon a change in activity in the LPAR acting as the network appliance, determining a set of business logic partitions served by the LPAR acting as the network appliance;
determining resource utilization of each business logic partition served by the LPAR acting as the network appliance;
determining whether each business logic partition served by the LPAR acting as the network appliance needs more or less resources;
determining availability of resources; and
allocating or deallocating resources to the business logic partitions served by the LPAR acting as the network appliance based on the need for resources and the availability of resources for each business logic partition.

2. The method of claim 1, wherein the step of monitoring activity of the LPAR acting as the network appliance includes detecting a change in activity of the LPAR acting as the network appliance.

3. The method of claim 1, wherein the step of monitoring activity of the LPAR acting as the network appliance includes receiving notification of a change in activity from the LPAR acting as the network appliance.

4. The method of claim 1, further comprising preemptively allocating additional resources to the business logic partitions served by the LPAR acting as a network application when a change in activity occurs in the LPAR acting as the network appliance.

5. The method of claim 1, further comprising automatically removing dynamic resources from other logical partitions when a change in activity occurs in the LPAR acting as the network appliance.

6. The method of claim 1, wherein the LPAR acting as a network appliance is predefined to act as a network appliance.

7. The method of claim 1, wherein the LPAR acting as a network appliance is an operating system LPAR created to act as a network appliance.

8. A system for emulating a network appliance in a logically partitioned environment, comprising:
a logical partition (LPAR) acting as a network appliance;
at least one business logical partition served by the LPAR acting as a network appliance; and
a management agent for monitoring activity of the LPAR acting as a network appliance, and, upon a change in activity in the LPAR acting as a network appliance, determining a set of business logic partitions served by the LPAR acting as the network appliance upon a change in activity in the LPAR acting as the network appliance, determining resource utilization of each business logic partition served by the LPAR acting as the network appliance, determining whether each business logic partition served by the LPAR acting as the network appliance needs more or less resources, determining availability of resources, and allocating or deallocating resources to the business logic partitions served by the LPAR acting as the network appliance based on the need for resources and the availability of resources for each business logic partition.

9. The system of claim 8, wherein the management agent monitors activity of the LPAR acting as the network appliance by detecting a change in activity of the LPAR acting as the network appliance.

10. The system of claim 8, wherein the management agent monitors activity of the LPAR acting as the network appliance by receiving notification of a change in activity from the LPAR acting as the network appliance.

11. The system of claim 8, wherein the management agent preemptively allocates additional resources to the business logic partitions served by the LPAR acting as a network application when a change in activity occurs in the LPAR acting as the network appliance.

12. The system of claim 8, wherein the management agent automatically removes dynamic resources from other logical partitions when a change in activity occurs in the LPAR acting as the network appliance.

13. The system of claim 8, wherein the LPAR acting as a network appliance is predefined to act as a network appliance.

14. The system of claim 8, wherein the LPAR acting as a network appliance is an operating system LPAR created to act as a network appliance.

15. An apparatus for emulating a network appliance in a logically partitioned environment, comprising:
A partition management module for monitoring activity of a logical partition (LPAR) acting as a network appliance; and
a partition service list indicating a set of business logic partitions served by the LPAR acting as the network appliance, wherein, upon a change in activity in the LPAR acting as the network appliance, the partition management module determines resource utilization of each business logic partition served by the LPAR acting as the network appliance, determines whether each business logic partition served by the LPAR acting as the network appliance needs more or less resources, determines availability of resources, and allocates or deallocates resources to the business logic partitions served by the LPAR acting as the network appliance based on the need for resources and the availability of resources for each business logic partition.

16. The apparatus of claim 15, wherein the partition management module monitors activity of the LPAR acting as the network appliance by detecting a change in activity of the LPAR acting as the network appliance.

17. The apparatus of claim 15, wherein the partition management module monitors activity of the LPAR acting as the network appliance by receiving notification of a change in activity from the LPAR acting as the network appliance.

18. The apparatus of claim 15, wherein the partition management module preemptively allocates additional resources to the business logic partitions served by the LPAR acting as a network application when a change in activity occurs in the LPAR acting as the network appliance.

19. The apparatus of claim 15, wherein the partition management module automatically removes dynamic resources from other logical partitions when a change in activity occurs in the LPAR acting as the network appliance.

20. The apparatus of claim 15, wherein the LPAR acting as a network appliance is predefined to act as a network appliance or is an operating system LPAR created to act as a network appliance.
